(19) United States
(12) Patent Application Publication
(10) Pub. No.: US 2011/0236003 A1
(43) Pub. Date: Sep. 29, 2011

(54) EnergySaver+

(76) Inventor: William Carroll, McKinleyville, CA (US)

(21) Appl. No.: 12/653,943

(22) Filed: Mar. 26, 2010

(51) Int. Cl. H05B 1/00

(52) U.S. Cl. 392/422

(57) ABSTRACT

This invention of process encompasses the use of infrared reflecting materials or coatings, lining any or all surfaces of an enclosure, to reflect and or redirect infrared emitter radiations toward the heating process target(s) and thereby increase rapidity of heat-rise in said process target(s) and/or reduce energy use to obtain or maintain a specified heat-rise in said target(s) of process.

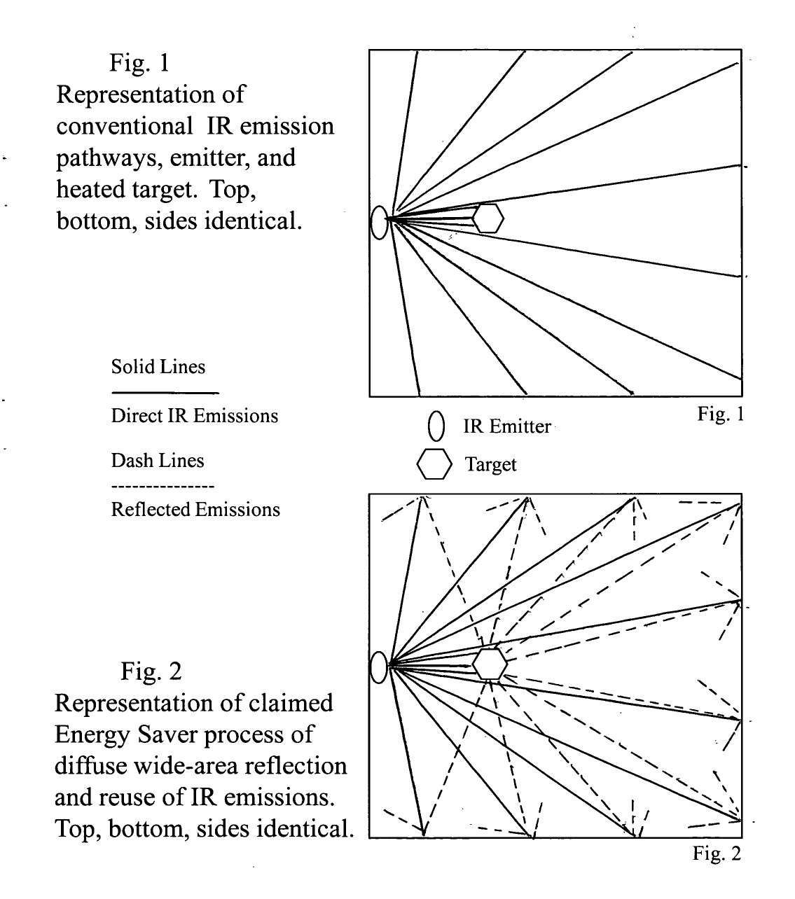

Boundary surface additions for process managed reflection of infrared emissions to accelerate target object(s) heat-buildup by means of radiation from infrared emitters, and by such managed reflection reduce energy consumption used to achieve or maintain heat-buildup objectives of process

### SUMMARY OF THE INVENTION

This invention of process takes advantage of the ability to reflect infrared emitter radiation and in the doing take heating benefit from rays commonly dissipated and wasted on off-target surfaces.

Such redirection of infrared emitter rays adds their heat-rise values to the target(s) of process and provides accelerated heat-rise values and/or a reduction in time, and energy use, to attain process specified heat levels.

Although the preferred embodiments of the present invention have been disclosed for illustrative purposes, those skilled in the art will appreciate that various modifications, additions and substitutions are possible, without departing from the scope and spirit of the invention as disclosed in the accompanying claims

1. The claim in this invention is use of infrared reflecting materials or coatings to control, redirect or enhance and/or reuse radiations of infrared emitters in the process management of heating targets in, or contents of, enclosures.
No claims are made relative to alteration of emissions from heat-reflecting surfaces, their coatings, attachments, supporting materials or structure of composition, or control of heat transfer into or from the interior or exterior of process enclosures
